(19) United States
(12) Patent Application Publication
(10) Pub. No.: US 2011/0302914 A1
(43) Pub. Date: Dec. 15, 2011

(54) HYDRAULIC DRIVE, IN PARTICULAR OF AN EXCAVATOR, IN PARTICULAR FOR A SLEWING GEAR

(76) Inventor: Frank Lothar Helbling, Sasbach (DE)

(21) Appl. No.: 12/674,547

(22) PCT Filed: May 8, 2008
(86) PCT No.: PCT/EP2008/003715

§ 371 Date: Apr. 4, 2011

(30) Foreign Application Priority Data
Aug. 23, 2007 (DE) 20 2007 011 783.3

(51) Int. Cl. F15B 1/027

(52) U.S. Cl. 60/416; 60/413

(57) ABSTRACT

The present invention relates to a hydraulic drive, in particular of an excavator, in particular for a slewing gear with a hydraulic circuit, which includes a pump and an engine, wherein a high pressure store is provided which can be connected to the pump and/or to the engine via at least one valve and a controller is provided which controls the at least one valve.

The present invention relates to a hydraulic drive, in particular of an excavator, in particular for a slewing gear, having a hydraulic circuit which includes a pump and an engine.

The hydraulically driven base functions of an excavator are equipment movements which are carried out via hydraulic cylinder drives as well as driving movements of the excavator and rotary movements of the superstructure which are produced via hydrostatic rotational drives. The hydraulic energy for this is provided by one or more pumps which are in turn driven by an internal combustion engine, in particular a diesel engine; in this respect, a pump transfer case is employed between the internal combustion engine and one or more pumps for the equipment movement and driving movement. A separate pump can in particular be used in this respect for the rotary movement of the superstructure.

The heat energy which arises in addition to the hydraulic energy and which heats the hydraulic fluid is dissipated again via radiators. The energy provided by the diesel engine is thus converted into hydraulic energy and losses.

A hydraulic drive is now in particular used for the rotary movement of the superstructure of a hydraulic excavator, in which movement the hydraulic energy provided by a pump is again transformed into mechanical energy in a hydraulic engine. The hydraulic engine thus generates the rotary movement in combination with a corresponding slewing gear transmission. The parameters of such a drive are the torque and the speed, with the torque being determined by the hydraulic engine, the pressure, the displacement volume and the transmission ratio and the speed being determined by the available oil volume flow, the displacement volume and the transmission ratio.

Two alternatives are essentially known from the prior art for the carrying out of the hydraulic drive:

The hydraulic drive can comprise an open hydraulic circuit in which the pump is in communication with the engine via a control valve. The working pump can in this respect be a fixed displacement pump or a variable displacement pump. The control valve controls the pressure and the quantity of the hydraulic fluid volume flow and thus controls the engine. The hydraulic fluid is sucked in by the pump from a return reservoir in which the hydraulic fluid flows back from the outlet of the engine. When the rotary movement is braked, the braking energy is hydraulically destroyed with such a control and is no longer available to the system.

A separate slewing gear pump is used for a closed circuit and is in communication with the engine without a valve in a closed circuit. In this respect, the pump is typically a variable displacement pump so that the pressure and quantity of the hydraulic fluid volume flow can be controlled via the pump. During a braking procedure, the slewing gear pump in such an arrangement is supported via the transmissions on the internal combustion engine so that the energy is theoretically available to other consumers. In actual operation, however, the energy is practically not needed at the time it is available and is thus lost.

It is therefore the object of the present invention to provide a hydraulic drive which has a lower energy consumption and in which in particular the energy is not lost on braking procedures.

This object is solved in accordance with the invention by a hydraulic drive in accordance with claim 1. A high-pressure store is provided in this respect which can be connected via at least one valve to the pump and/or to the engine and a controller is provided which controls the at least one valve. This high pressure store makes it possible to store hydraulic energy and to make it available to the drive again later. By switching in the high pressure store via the valve, said high pressure store can e.g. be filled during the braking of the slewing gear via the engine working as a pump to give back the energy again which was stored on the reacceleration of the slewing gear. A low energy consumption of the hydraulic drive hereby results, whereby in particular the internal combustion engine can be dimensioned smaller for the drive of the pump. The high pressure store can equally also be charged via the pump. If the high pressure store is separated from the hydraulic circuit via the valve, the hydraulic drive of the present invention, in contrast, again works like a hydraulic drive in accordance with the prior art in which the pump drives the engine.

The internal combustion engine used to drive the pump can thus be dimensioned smaller since the energy from the high pressure store can be used in a supporting manner during power peaks. Manufacturing costs can be lowered, on the one hand, by the smaller dimensioned internal combustion engine; on the other hand, the total consumption of the hydraulic drive also reduces since the internal combustion engine is loaded more uniformly and can also be operated at a better engine operating point in normal operation due to the smaller dimensioning.

The high pressure store can advantageously be connected to the pump and/or to the engine at least two different points in the hydraulic circuit via the at least one valve. The high pressure store can be connected to the one connection point to be charged and to the other connection point to output the stored energy again in the form of hydraulic fluid. Different conveying directions of the pump or of the engine are thus also possible.

Further advantageously, the controller switches the at least one valve so that hydraulic fluid is conveyed into the high pressure store in an energy storage mode and hydraulic fluid flows out of the high pressure store in an energy recovery mode. Energy can thus be stored by the controller, e.g. on braking or at low loads of the pump, and can be returned again on accelerations.

Further advantageously, the controller switches the at least one valve so that the pump and the engine communicate with one another in a closed circuit in a normal mode. Such a closed circuit of pump and engine is in particular of advantage over an open circuit with slewing gear drives and can serve for the direct drive of the engine via the pump in phases in which energy is neither stored nor recovered.

In this respect, the high pressure store is advantageously separated from the closed circuit of pump and engine in the normal mode. In contrast to hydraulic circuits with secondary regulation, in which a store is in constant communication with the pressure line between the pump and the engine, a fixed displacement engine can hereby be used, whereas the control of the hydraulic drive takes place via a variable adjustment pump. A simpler and more inexpensive design thus results.

Further advantageously, the hydraulic drive in accordance with the invention includes a low pressure store which can be connected to the pump and/or to the engine via at least one valve, with the controller controlling the at least one valve. In this respect, it can be the same valve via which the high pressure store can also be connected to the hydraulic circuit. Alternatively, however, separate valves or valve combination can also be used. The low pressure store then provides the hydraulic fluid which is conveyed into the high pressure store in the energy storage mode and, conversely, accepts the hydraulic fluid which flows out of the high pressure store in the energy recovery mode.

In this respect, the low pressure store can advantageously be connected to the pump and/or to the engine at least two different points in the hydraulic circuit via the at least one valve. Depending on whether energy is stored or recovered, the low pressure store can thus be connected to the pump and/or to the engine at the corresponding positions. Different directions of rotation of the engine or of the pump are equally possible.

The controller advantageously switches the at least one valve such that hydraulic fluid flows out of the low pressure store in the energy storage mode and hydraulic fluid flows into the low pressure store in the recovery mode. There is therefore no closed hydraulic circuit with the hydraulic drive in accordance with the invention during the energy storage mode and the energy recovery mode; the hydraulic fluid rather either flows from the high pressure store into the low pressure store and thus outputs energy to the hydraulic drive or hydraulic fluid is conveyed from the low pressure store into the high pressure store and thus stores hydraulic energy.

The controller furthermore advantageously switches the at least one valve such that the low pressure store is separated from the closed circuit of pump and engine in a normal mode. The advantageous closed circuit of engine and pump already described above thus results in the normal mode, whereas the valve switches so that no closed circuit is present in the energy storage mode and in the energy recovery mode.

Whereas the high pressure store is in this respect advantageously completely separated from the closed circuit of pump and engine in the normal mode, the low pressure store will advantageously communicate via check valves with the low pressure side of the closed circuit to provide it with hydraulic fluid if required. The low pressure store thus satisfies a dual function in the hydraulic system in accordance with the invention. In normal operation, it works as is known from the prior art via the check valves as a hydraulic fluid supply of the low pressure side, for which purpose it is advantageously charged with admission pressure via a pump. In the energy storage mode, in contrast, it serves as a hydraulic fluid source for the hydraulic fluid conveyed into the high pressure store; in the energy recovery mode is serves as a hydraulic fluid receiver for the hydraulic fluid flowing out of the high pressure store. For this purpose, it is advantageously correspondingly connected to the engine or to the pump during these modes. In this respect, there is advantageously no closed circuit of pump and engine in the energy storage mode and/or in the energy recovery mode.

The high pressure store in the hydraulic drive can advantageously be connected to at least an inflow side of the pump via the at least one valve in the hydraulic drive in accordance with the invention. The high pressure store can thus be connected to the inflow of the pump during the energy recovery mode and can thus support the pump. The pressure difference over the pump and thus the power required to drive the pump is reduced by the high pressure store connected to the inflow side of the pump. The internal combustion engine used to drive the pump can thus be dimensioned smaller since the pump can be supported by the high pressure store during power peaks.

Further advantageously, the high pressure store can be connected via the at least one valve to both sides of the pump. The high pressure store can thus be connected to the respective inflow side in dependence on the running direction of the pump, in particular when the pump is a pump with two conveying directions. This in addition also makes it possible to charge the high pressure store via the pump. During operating phases of the hydraulic drive in which the hydraulic engine is not required, the internal combustion engine can nevertheless continue to drive the pump and store the energy in the high pressure store in order to return the energy again during phases with high load. The hydraulic fluid can thus also be pumped into the high pressure store during braking phases in which the engine of the hydraulic drive acts as a pump. It is sufficient for this purpose if, in such braking phases, the high pressure store is e.g. in communication with the outflow side of the pump.

Further advantageously, the low pressure store can be connected via the at least one valve to at least an outflow side of the engine. The hydraulic fluid flowing in from the high pressure store can thus flow into the low pressure store during the energy recovery after it has left the engine.

Further advantageously, the low pressure store can be connected via the at least one valve to both sides of the engine. This in particular allows the energy recovery in both directions of rotation with an engine having two running directions. The engine can thus also work as a pump during braking phases and can pump hydraulic fluid from the low pressure store into the high pressure store, with the low pressure store then being connected to the outflow side of the engine.

The controller of the hydraulic drive in accordance with the invention advantageously switches the at least one valve so that, in a first energy storage mode, a hydraulic connection of low pressure store, engine, possibly pump and high pressure store, is present, with the engine working as a pump. As already described above, the braking energy can thus be stored in that hydraulic fluid is pumped from the low pressure store into the high pressure store via the engine working as a pump. The fluid can then either be pumped directly from the engine into the high pressure store or still run via the pump.

The controller of the hydraulic, drive in accordance with the invention further advantageously controls the at least one valve such that, in a second energy storage mode, a hydraulic connection of low pressure store, pump and high pressure store is present and the engine is advantageously separate therefrom, with the pump pumping hydraulic fluid into the high pressure store. It is thus possible to store additional energy in phases in which the internal combustion engine driving the pump only has to output a little power due to the cycle. This energy is then available for support in phases in which a high power is required of the internal combustion engine. The power output of the internal combustion engine can thus be kept almost constant over the total cycle and an operating point of the internal combustion engine can be selected which is favorable with respect to the consumption. The internal combustion engine can equally thus be dimensioned correspondingly smaller.

Further advantageously, the controller of the hydraulic drive in accordance with the invention switches the at least one valve such that, in a first energy recovery mode, a hydraulic connection of high pressure store, pump, engine and low pressure store is present so that the pressure from the high pressure store supports the function of the pump. As already discussed, the pressure difference at the pump reduces by the connection between the high pressure store and the inflow side of the pump so that a lower drive power is required to drive the pump. The function of the pump can thus be supported during acceleration phases in that the stored energy is recovered and is made available to the hydraulic pump.

Further advantageously, the controller of the hydraulic drive in accordance with the invention switches the at least one valve so that, in a second energy recovery mode, a hydraulic connection of high pressure store, pump and low pressure store is present and the engine is advantageously separated therefrom, with the pump serving as an engine.

This is in particular of advantage if the pump is driven by a drive engine, in particular an internal combustion engine, which also drives further consumers. The additional drive torque of the pump can thus be provided to other consumers via the transfer case. In this respect, the energy from the high pressure store drives the pump, while the hydraulic fluid flows into the low pressure store.

Further advantageously, the controller switches into an energy saving mode, in particular into the first energy storage mode, in braking phases of the drive, with the engine serving as a pump, and as required into an energy recovery mode, in particular into the first energy recovery mode, in acceleration phases. The braking energy can thus be stored during braking phases and is not lost, but can be returned during acceleration phases.

Further advantageously, the controller switches into the second energy storage mode in phases in which the drive engine driving the pump is less loaded. The power output of the internal combustion engine can thus be kept almost constant, which has a positive effect on consumption and dimensioning of the internal combustion engine. Further advantageously, the controller switches into the second energy recovery mode, in phases in which the drive engine driving the pump is highly loaded, in particular to make the energy then provided by the pump working as an engine available to other consumers.

The engine and the pump advantageously have two conveying directions in the hydraulic drive in accordance with the invention. The direction of rotation of the engine can thus be set via the conveying direction of the pump in a closed circuit.

Further advantageously, the at least one valve enables at least the following three connection possibilities:
The high pressure store is connected to a first side of the pump, the low pressure store is connected to a first side of the engine, the second sides of the engine and the pump are connected to one another: Depending on the running direction of the pump and the engine, either the high pressure store can thus be charged in that the engine works as a pump or the high pressure store can support the work of the pump;
The high pressure store is connected to the second side of the pump, the low pressure store is connected to the second side of the engine, the first sides of the engine and the pump are connected to one another; this is the mirror-image situation of the first connection combination so that the corresponding functions can be realized for reversed directions of rotation of the engine and the pump;
The high pressure store and the low pressure store are separate from the pump and the engine, the first and second sides of the engine and the pump are each connected to one another: in this normal operating state, a closed circuit of the pump and the engine therefore results.

In particular the first energy storage and energy recovery modes can be carried out by these three connection combinations.

Further advantageously, the valve enables the connection combination: The high pressure store is connected to a first side of the pump, the low pressure store is connected to a second side of the pump, the engine is advantageously separate from the pump and the stores. Either the second energy storage mode or the second energy recovery mode can be carried out by this arrangement depending on the direction of rotation of the pump.

Further advantageously, the pump of the hydraulic drive in accordance with the invention is a variable displacement pump and/or the engine of the hydraulic drive in accordance with the invention is a fixed displacement engine. The hydraulic drive can thus be controlled via the pivot angle of the variable displacement pump, whereas the engine can be designed as a fixed displacement engine. A simple control of the system in accordance with the invention hereby results, with the energy storage and energy recovery modes in accordance with the invention also being able to be carried out by a corresponding control of the variable displacement pump.

Further advantageously, the pivot angle of the pump in this respect serves as the input value of the controller.

Further advantageously, at least one pressure sensor is furthermore provided for the measurement of a hydraulic pressure which supplies the controller with data.

Further advantageously, the controller of the hydraulic drive in accordance with the invention processes control signals of the operator.

The input values of the controller are thereby the control signals of the operator, the pressures at different points in the circuit and the pivot angle of the pump. The output values are in this respect advantageously the control signals for the pump and the control signals for the at least one valve.

The possibility results by the controller in accordance with the invention of carrying out, in addition to the customary slewing gear control in accordance with the prior art, the hydraulic storage management in accordance with the invention by which energy can be saved and in particular a smaller internal combustion engine can be used for the drive of the pump, whereby in turn the consumption and the manufacturing costs are cut and in addition the noise pollution falls. The control for this purpose controls the pump correspondingly to achieve the advantages in accordance with the invention.

Further advantageously, the controller communicates with the drive electronics of the drive engine driving the pump to ensure a uniform capacity utilization of the drive engine. A uniform capacity utilization of the drive engine, which cuts the consumption and the noise emission, can hereby in particular be provided by use of the second energy storage mode and, optionally, via the second energy recovery mode. The controller is in this respect advantageously an electronic controller system which advantageously comprises a microcontroller and the corresponding sensor system for the pressures and for the pivot angle of the pump.

The present invention furthermore includes a slewing gear, in particular of an excavator with a hydraulic drive, such as was described above. The same advantages result by such a slewing gear, in particular of a hydraulic excavator, which were described above in connection with the hydraulic drive.

The present invention moreover includes an excavator having a hydraulic drive, in particular for the slewing gear, as was described above. The advantages in accordance with the invention also result hereby.

The present invention furthermore also includes the corresponding methods for the control of a hydraulic drive, in particular of an excavator, and in this respect in particular of the slewing gear, by which the valves and, optionally, the pump are controlled so that the corresponding energy storage and energy recovery modes are carried out.

The present invention will now be described in more detail with reference to embodiments and drawings.

There are shown

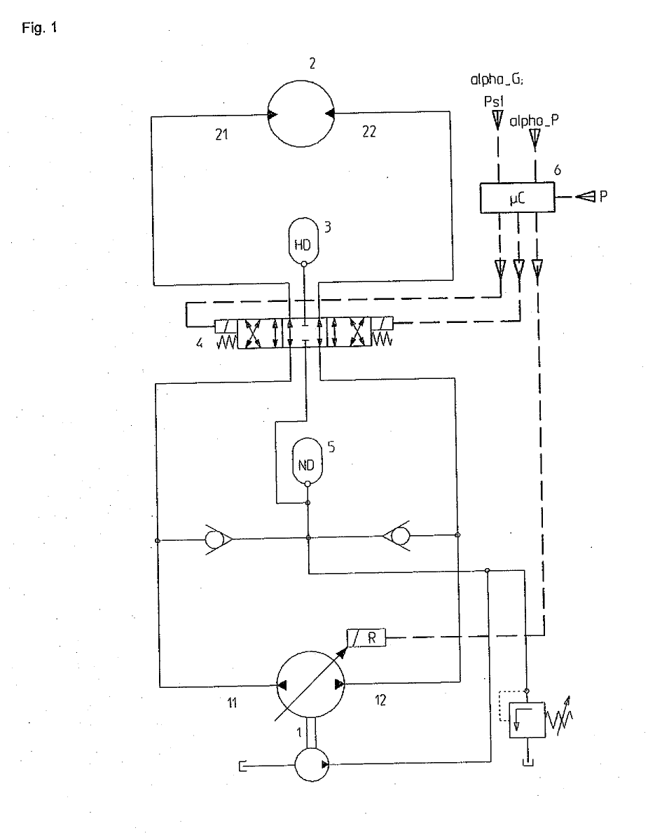

FIG. 1 a first embodiment of the hydraulic drive of the present invention;

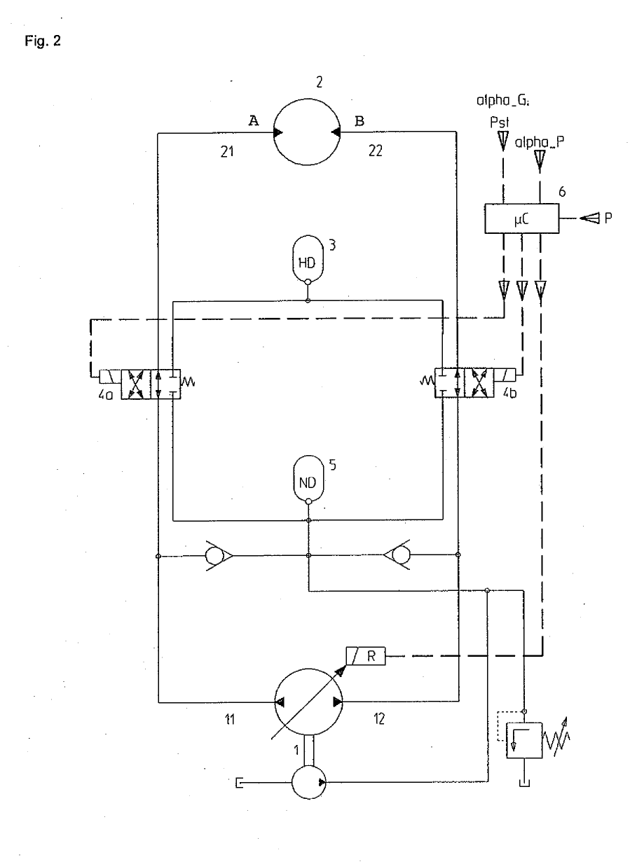

FIG. 2 a second embodiment of the hydraulic drive of the present invention; and

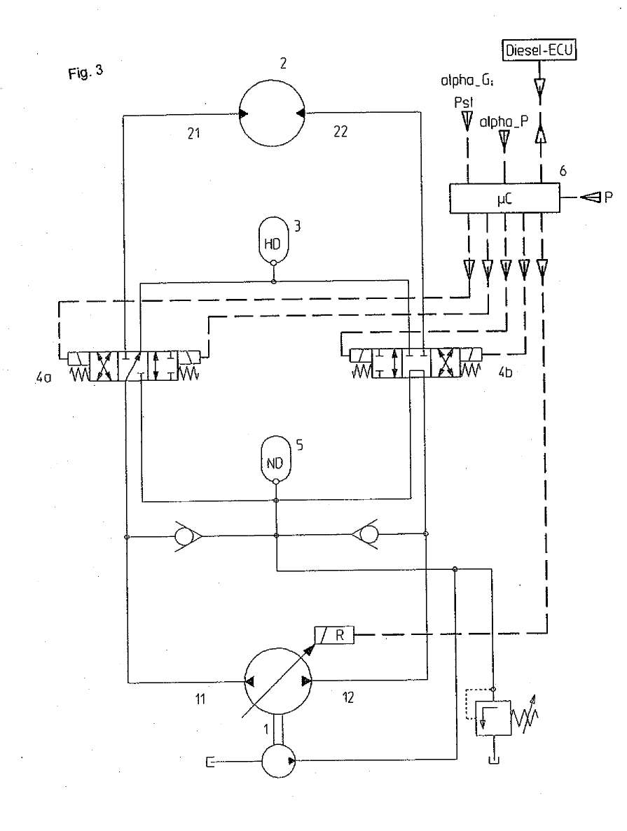

FIG. 3 a third embodiment of the hydraulic drive of the present invention.

FIG. 1 shows a first embodiment of the hydraulic drive in accordance with the invention in which the energy from the braking can be stored in the high pressure store (3) during braking phases of the slewing gear in the first energy storage mode in accordance with the invention and this energy can again be returned to the drive on the reacceleration of the rotary drive in the first energy recovery mode. The diesel engine can thus be dimensioned correspondingly smaller.

The hydraulic drive in accordance with the invention in the first embodiment in this respect comprises the pump (1) and the engine (2), here a variable displacement axial piston pump and a fixed displacement engine each having two conveying directions. The high pressure store (3) can here be connected via the valve (4), here a 6/3 way valve, in a right hand position of the valve (4) to the left hand side (11) of the pump (1); in the left hand position of the valve (4) to the right hand side (12) of the pump (1). Accordingly, in the right hand position of the valve (4), the low pressure store (5) is connected to the left hand side (21) of the engine (2), while the low pressure store (5) is connected to the right hand side (22) of the engine in the left hand position of the valve (4). The left hand side (11) of the pump and the left hand side (21) of the engine (2) are accordingly connected to one another in the left hand position of the valve (4), while the right hand side (12) of the pump (1) and the right hand side (22) of the engine (2) are connected to one another in the right hand position of the valve.

In the middle position of the valve (4), in contrast, the high pressure store (3) and the low pressure store (5) are separate from the engine (1) and the pump (2), while the left hand side (11) of the pump (1) is in communication with the left hand side (21) of the pump (2) and the right hand side (12) of the pump (1) is in communication with the right hand side (22) of the engine (2).

The lower pressure store (5) is constantly in communication with the left hand side (11) and the right hand side (12) of the pump (1) via two check valves in order also potentially to supply the low pressure side of the hydraulic circuit with hydraulic fluid during the normal operation with a closed circuit. Furthermore, the low pressure store (5) is charged with admission pressure via a pump. This is shown connected to the main pump here. A relief valve is equally provided which is in communication with the low pressure store.

The controller (6), here a microcontroller, controls the valve (4) and the variable displacement pump (1). The pressures in the hydraulic system and the pivot angle of the pump serve as the input values. Control signals of the operator are equally input values of the controller (6). The controller (6) thus takes over the storage management in accordance with the invention and the stewing gear control.

In this respect, the valve (4) is moved into the left hand position or into the right hand position in dependence on the direction of rotation of the engine (2) in the first energy storage mode of the present invention in the first embodiment shown in FIG. 1. The engine (2) thus becomes the pump and the pump (1) becomes the engine on the braking of the superstructure. The low pressure store (5) is connected to the inflowing side of the engine via the valve, while the high pressure store (3) is connected to the outflowing side of the pump (1) via the valve (4). The engine (2) which acts as a pump and which is driven by the movement energy of the superstructure thus conveys hydraulic fluid from the low pressure store (5) into the high pressure store (3). The movement energy of the superstructure on the braking can thus be stored as hydraulic energy in the high pressure store (3).

In the first energy recovery mode, the valve (4) is in the left hand position or on the right hand position depending on the direction of rotation of the pump (1) and the engine (2), with it being in precisely the opposite position in comparison with the first energy storage mode with the same conveying direction. The high pressure store is thus connected to the inflow side of the pump (1) via the valve (4), while the low pressure store is connected to the outflow side of the engine (2). The delta p at the pump is hereby reduced and thus the power required to operate the pump. In this connection, hydraulic fluid flows from the high pressure store (3) via the pump and the engine (2) into the low pressure store (3) and in so doing converts the stored hydraulic energy into mechanical energy again. The acceleration of the stewing gear can thus be supported by the stored energy.

The second embodiment shows a variant of the first embodiment which is identical thereto except for the different design of the valves. Instead of the 6/3 way valve from the first embodiment, in the second embodiment a left hand 4/2 valve (4a) and a right hand 4/2 valve (4b) are used which, however, have the same functionality as the 6/3 way valve (4) of the first embodiment. If the left hand valve (4a) is in its left hand position and if the right hand valve (4b) is in its right hand position, as shown in FIG. 2, the closed circuit of the pump and the engine results which is required for the normal mode and in which the left hand side (11) of the pump (1) is in communication with the left hand side (21) of the engine (2) and the right hand side (12) of the pump (1) is in communication with the right hand side (22) of the engine (2), while the high pressure store (3) and the low pressure store (5) are separate from the pump and the engine. If, in contrast, the left hand valve (4a) is in its left hand position, while the right hand valve (4b) is also in its left hand position, the high pressure store (3) is connected to the right hand side of the pump (1), while the low pressure store (5) is connected to the right hand side (22) of the engine (2). If, in contrast, the left hand valve (4a) is in its right hand position, while the right hand valve (4b) is in its left hand position, the high pressure store (3) is connected to the left hand side (11) of the pump (1), while the low pressure store (5) is connected to the left hand side (21) of the engine (2). The valves (4a) and (4b) can thus establish the connections required for the normal mode, for the first energy storage mode and for the first energy recovery mode via the controller (6), which controls them, just as also in the first embodiment. The respective conveying direction is then effected by setting the adjustment angle of the pump (1) via the controller.

The third embodiment shown in FIG. 3 is identical in a connection aspect to the second embodiment, but with the left hand valve (4a) and the right hand valve (4b) each having a central position in addition to the left hand position and right hand position known from the second embodiment. In its middle position, the left hand valve (4a) connects the high pressure store (3) to the left hand side (11) of the pump, while no connection is established between the low pressure store (5) and the left hand side (21) of the engine (2). The right hand valve (4b), in contrast, in its middle position, connects the low pressure store (5) to the right hand side (12) of the pump (1), while the high pressure store (3) is separate from the right hand side (22) of the engine (2).

It becomes possible by this arrangement of the 4/3 way valves (4a) and (4b) also to carry out the second energy storage and energy recovery modes with the embodiment shown in FIG. 3.

Since the engine is separate from the pump in the middle position of the valves (4a) and (4b) and the pump is connected to the low pressure store and to the high pressure store, the high pressure store can be charged by outward pivoting of the pump into the corresponding direction, which corresponds to the second energy storage mode. The low pressure side of the pump in this respect is supplied from the low pressure store (5). If the high pressure store (3) is filled accordingly, the pump (1) is pivoted back to zero. Additional energy can thus be stored in phases in which the drive engine provided for the operation of the pump (1) has to provide little power due to the cycle.

By outwardly pivoting the pump (1) in the other direction, the pump can, in contrast, be used as an engine in the middle position of the valves (4a) and (4b). The hydraulic fluid in this respect flows out of the high pressure store (3) via the pump (1) to the low pressure store (5) so that the energy stored in the high pressure store (3) drives the pump (1) working as an engine. The additional drive torque can then be made available to other consumers via a transfer case.

It is naturally also equally possible with the third embodiment shown in FIG. 3 to carry out the first energy storage and energy recovery modes. The procedure for this purpose is the same as in the first and second embodiments.

Due to the energy storage and energy recovery in accordance with the invention, the diesel engine driving the pump (1) can be dimensioned correspondingly smaller, which saves costs, construction size and weight. The consumption can equally be correspondingly lowered.

Furthermore, the operating point of the internal combustion engine can be selected to be more favorable with respect to the consumption if the diesel engine does not have to be configured to cover load peaks during the acceleration phases. In particular the second energy storage mode additionally makes it possible to keep the power output of the diesel engine almost constant over the total cycle, which in turn optimizes the energy consumption. In addition, the diesel engine can thus be dimensioned even smaller, with load peaks of other consumers also being able to be cushioned by the second energy recovery mode.

1. A hydraulic drive, in particular of an excavator, in particular for a slewing gear, comprising a hydraulic circuit which includes a pump (1) and an engine (2),
wherein
a high pressure store (3) is provided which can be connected via at least one valve (4, 4a, 4b) to the pump (1) and/or to the engine (2), and a controller (6) is provided which controls the at least one valve (4, 4a, 4b).

2. A hydraulic drive in accordance with claim 1, wherein the high pressure store (3) can be connected to the pump (1) and/or to the engine (2) at least two different points in the hydraulic circuit via the at least one valve (4, 4a, 4b).

3. A hydraulic drive in accordance with claim 1, wherein the controller (6) switches the at least one valve (4, 4a, 4b) so that hydraulic fluid is conveyed into the high pressure store (3) in an energy storage mode and hydraulic fluid flows out of the high pressure store (3) in an energy recovery mode.

4. A hydraulic drive in accordance with claim 1, wherein the controller (6) switches the at least one valve (4, 4a, 4b) so that the pump (1) and the engine (2) are in communication with one another in a closed circuit in a normal mode.

5. A hydraulic drive in accordance with claim 4, wherein the high pressure store (3) is separate from the closed circuit of pump (1) and engine (2) in the normal mode.

6. A hydraulic drive in accordance with claim 1, comprising a low pressure store (5) which can be connected to the pump (1) and/or to the engine (2) via at least one valve (4, 4a, 4b), with the controller (6) controlling the at least one valve (4, 4a, 4b).

7. A hydraulic drive in accordance with claim 6, wherein the low pressure store (5) can be connected to the pump (1) and/or to the engine (2) at least two different points in the hydraulic circuit via the at least one valve (4, 4a, 4b).

8. A hydraulic drive in accordance with claim 6, wherein the controller (6) switches the at least one valve (4, 4a, 4b) so that hydraulic fluid flows out of the low pressure store (5) in the energy storage mode and hydraulic fluid flows into the low pressure store (5) in the energy recovery mode.

9. A hydraulic drive in accordance with claim 6, wherein the controller (6) switches the at least one valve (4, 4a, 4b) so that the low pressure store (5) is separate from the closed circuit of pump (1) and engine (2) in the normal mode.

10. A hydraulic drive in accordance with claim 6, wherein no closed circuit of pump (1) and engine (2) is present in the energy storage mode and/or in the energy recovery mode.

11. A hydraulic drive in accordance with claim 1, wherein the high pressure store (3) can be connected to an inflow side (11, 12) of the pump (1) via the at least one valve (4, 4a, 4b).

12. A hydraulic drive in accordance with claim 1, wherein the high pressure s tore (3) can be connected to both sides (11, 12) of the pump (1) via the at least one valve (4, 4a, 4b).

13. A hydraulic drive in accordance with claim 1, wherein the low pressure store (5) can be connected to at least one outflow side (21, 22) of the engine via the at least one valve (4, 4a, 4b).

14. A hydraulic drive in accordance with claim 1, wherein the low pressure store (5) can be connected to both sides (21, 22) of the engine via the at least one valve (4, 4a, 4b).

15. A hydraulic drive in accordance with claim 1, wherein the controller (6) switches the at least one valve (4, 4a, 4b) so that a hydraulic connection of low pressure store (5), engine, potentially pump (1) and high pressure store (3) is present in a first energy storage mode, with the engine (2) working as a pump (1).

16. A hydraulic drive in accordance with claim 1, wherein the controller (6) switches the at least one valve (4, 4a, 4b) so that a hydraulic connection of low pressure store (5), pump (1) and high pressure store (3) is present in a second energy storage mode and the engine (2) is advantageously separate therefrom, with the pump (1) pumping hydraulic fluid into the high pressure store (3).

17. A hydraulic drive in accordance with claim 1, wherein the controller (6) switches the at least one valve (4, 4a, 4b) so that a hydraulic connection of high pressure store (3), pump (1), engine (2) and low pressure store (5) is present in a first energy recovery mode so that the pressure from the high pressure store (3) supports the function of the pump (1).

18. A hydraulic drive in accordance with claim 1, wherein the controller (6) switches the at least one valve (4, 4a, 4b) so that a hydraulic connection of high pressure store (3), pump (1) and low pressure store (5) is present in a second energy recovery mode and the engine (2) is advantageously separate therefrom, with the pump (1) serving as an engine (2).

19. A hydraulic drive in accordance with claim 1, wherein the pump (1) is driven by a drive engine, in particular by an internal combustion engine, which drives further consumers.

20. A hydraulic drive in accordance with claim 1, wherein the controller (6) switches into an energy storage mode, in particular into the first energy storage mode, in braking phases of the drive, with the engine (2) serving as a pump (1), and wherein it optionally switches into an energy recovery mode, in particular the first energy recovery mode, in acceleration phases.

21. A hydraulic drive in accordance with claim 1, wherein the controller (6) switches into the second energy storage mode in phases in which the drive engine driving the pump (1) has a small load.

22. A hydraulic drive in accordance with claim 1, wherein the controller (6) switches into the second energy recovery mode in phases in which the drive engine driving the pump (1) has a high load.

23. A hydraulic drive in accordance with claim 1, wherein the engine (2) and the pump (1) have two conveying directions.

24. A hydraulic drive in accordance with claim 1, wherein the at least one valve (4, 4a, 4b) enables at least the three connection combinations
High pressure store (3) is connected to a first side of the pump (1), low pressure store (5) is connected to a first side of the engine, the two sides of the engine (2) and the pump (1) are connected to one another;
High pressure store (3) is connected to the second side of the pump (1), low pressure store (5) is connected to the second side of the engine, the first sides of the engine (2) and the pump (1) are connected to one another;
High pressure store (3) and low pressure store (5) are separate from the pump (1) and the engine (2), the first and second sides of the engine (2) and the pump (1) are each connected to one another.

25. A hydraulic drive in accordance with claim 1, wherein the at least one valve (4, 4a, 4b) enables at least the connection combinations
High pressure store (3) is connected to a first side of the'pump (1), low pressure store (5) is connected to a second side of the pump (1), the engine (2) is advantageously separate from the pump (1) and stores.

26. A hydraulic drive in accordance with claim 1, wherein the pump (1) is a variable displacement pump and/or the engine (2) is a fixed displacement engine.

27. A hydraulic drive in accordance with claim 26, wherein the pivot angle of the pump (1) serves as an input signal of the controller (6).

28. A hydraulic drive in accordance with claim 1, wherein at least one pressure sensor is provided which supplies the controller (6) with measurement data for the measurement of a hydraulic pressure.

29. A hydraulic drive in accordance with claim 1, wherein the controller (6) processes control signals of the operator.

30. A hydraulic drive in accordance with claim 1, wherein the controller (6) controls the pump (1).

31. A hydraulic drive in accordance with claim 1, wherein the controller (6) communicates with the electronic driving system of the drive engine driving the pump (1) to ensure a uniform capacity utilization of the drive engine.

32. A slewing gear, in particular of an excavator having a hydraulic drive, in accordance with claim 1.

33. An excavator comprising a hydraulic drive, in particular for the slewing gear, in accordance with claim 1.
